(19) United States
(12) Patent Application Publication
(10) Pub. No.: US 2013/0282235 A1
(43) Pub. Date: Oct. 24, 2013

(54) DEPLOYABLE TRACTION ASSEMBLY

(71) Applicants: Kendall Kamminga, Neerlandia (CA); Jonathan Tyler, Edmonton (CA)

(72) Inventors: Kendall Kamminga, Neerlandia (CA); Jonathan Tyler, Edmonton (CA)

(21) Appl. No.: 13/867,878

(22) Filed: Apr. 22, 2013

Related U.S. Application Data
(60) Provisional application No. 61/636,288, filed on Apr. 20, 2012.

(51) Int. Cl. B60B 39/00

(52) U.S. Cl. CPC B60B 39/00
USPC 701/36; 280/757

(57) ABSTRACT

A deployable traction assembly comprising a studded mud flap mounted for retraction and extension on the vehicle by operation of a motor. The motor may have a shaft connected via spools and straps to the studded mud flaps. The studded mud flap may be mounted on the vehicle behind or in front of a set of wheels within a distance such that when the studded mud flap is extended and the vehicle moved backward or forward, the studded mud flap may extend under a set of wheels. The deployable traction assembly may include one or more sensors connected to sense position of the studded mud flap or load on a part of the deployable traction assembly, such as the shaft of the motor. A processor may be connected to receive signals from the one or more sensors and provide output for controlling the motor based on the received signals.

### TECHNICAL FIELD

Vehicle accessories.

### BACKGROUND

U.S. Pat. No. 4,386,681 discloses a belt that is mounted forward of a set of wheels on the vehicle and that may be lowered under the wheels to help stop the vehicle.

### SUMMARY

The inventor has identified a need to prevent vehicles sliding on slippery roads. A deployable traction assembly is provided comprising a studded mud flap mounted for retraction and extension on the vehicle by operation of a motor. The motor may have a shaft connected via spools and straps to the studded mud flaps. The studded mud flap may be mounted on the vehicle behind a set of wheels within a distance such that when the studded mud flap is extended and the vehicle moved backward, the studded mud flap may extend under at least a wheel of the set of wheels. The deployable traction assembly may include one or more sensors connected to sense position of the studded mud flap or load on a part of the deployable traction assembly, such as the shaft of the motor. A processor may be connected to receive signals from the one or more sensors and provide output for controlling the motor based on the received signals.

In various embodiments, there may be included any one or more of the following features: the deployable traction assembly is mounted on a vehicle behind a set of wheels within a distance such that when the straps are unwound from the spools and the vehicle moved backward to roll over the mud flap, the studded mud flap may extend under at least a wheel of the set of wheels; the studded mud flap has a first face and a second face and studs protrude through the studded mud flap and extend beyond each of the first face and the second face; the processor is configured on response to a start signal to run the motor for a predetermined period of time; a load sensor and/or a position sensor respectively sense load on the shaft, straps or studded mud flap or position of the shaft or the straps or the studded mud flap; a processor is configured to respond to a load beyond a predetermined threshold to send a signal to the motor to reduce the load by spooling forward or backward; and a chock is mounted for deployment with or independently of the mud flaps.

In one embodiment, there is disclosed a deployable traction assembly, comprising a motor having a shaft; one or more spools mounted for rotation on the shaft; one or more straps, each strap having a first end wound on a respective one of the one or more spools and a second end; and a studded mud flap connected to the second end of each of the one or more straps.

In another embodiment, there is disclosed a vehicle having a deployable traction assembly, the deployable traction assembly comprising a studded mud flap mounted for retraction and extension on the vehicle by operation of a motor; and the studded mud flap being mounted on the vehicle behind a set of wheels within a distance such that when the studded mud flap is extended and the vehicle moved backward, the studded mud flap may extend under at least a wheel of the set of wheels.

In another embodiment, there is disclosed a deployable traction assembly, comprising a studded mud flap connected to a motor for retraction and extension when mounted on a vehicle; one or more sensors connected to sense position of the studded mud flap or load on the studded mud flap; and a processor connected to receive signals from the one or more sensors and provide output for controlling the motor based on the received signals.

### BRIEF DESCRIPTION OF THE FIGURES

Embodiments will now be described with reference to the figures, in which like reference characters denote like elements, by way of example, and in which:

FIG. 1 shows a deployable mud flap suspended from spools on a shaft by straps;

FIG. 2 is an exploded view of FIG. 1;

FIG. 3 shows deployable mud flaps of FIG. 1 mounted in tandem with covers over the spools;

FIGS. 4A and 4B show respectively a deployable mud flap of FIG. 1 mounted on the rear of a vehicle rearward of all wheels on the vehicle in a retracted and deployed position;

FIG. 4C shows a deployable mud flap mounted between two sets of wheels on a vehicle such as a tractor trailer, such that the mud flap traction device may be deployed under the forward set of wheels or the rearward set of wheels depending on whether better traction would be achieved by moving forward or backward;

FIG. 5 is a schematic of a control system for the deployable mud flap of FIG. 1;

FIGS. 6A and 6B show an embodiment of a deployable mud flap with a chock in respective undeployed and deployed positions; and

FIG. 7 shows an embodiment in which the gripping elements are provided between the straps.

### DETAILED DESCRIPTION

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

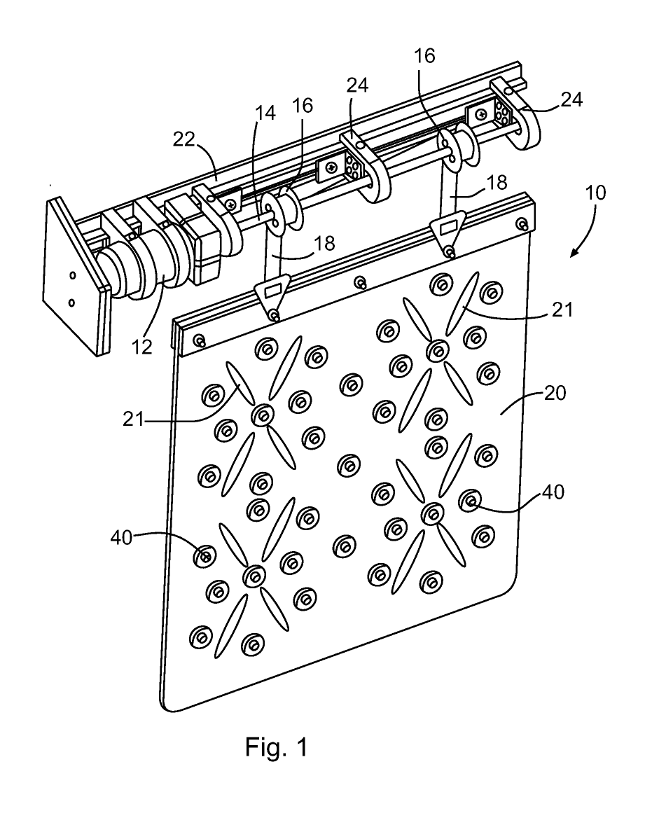

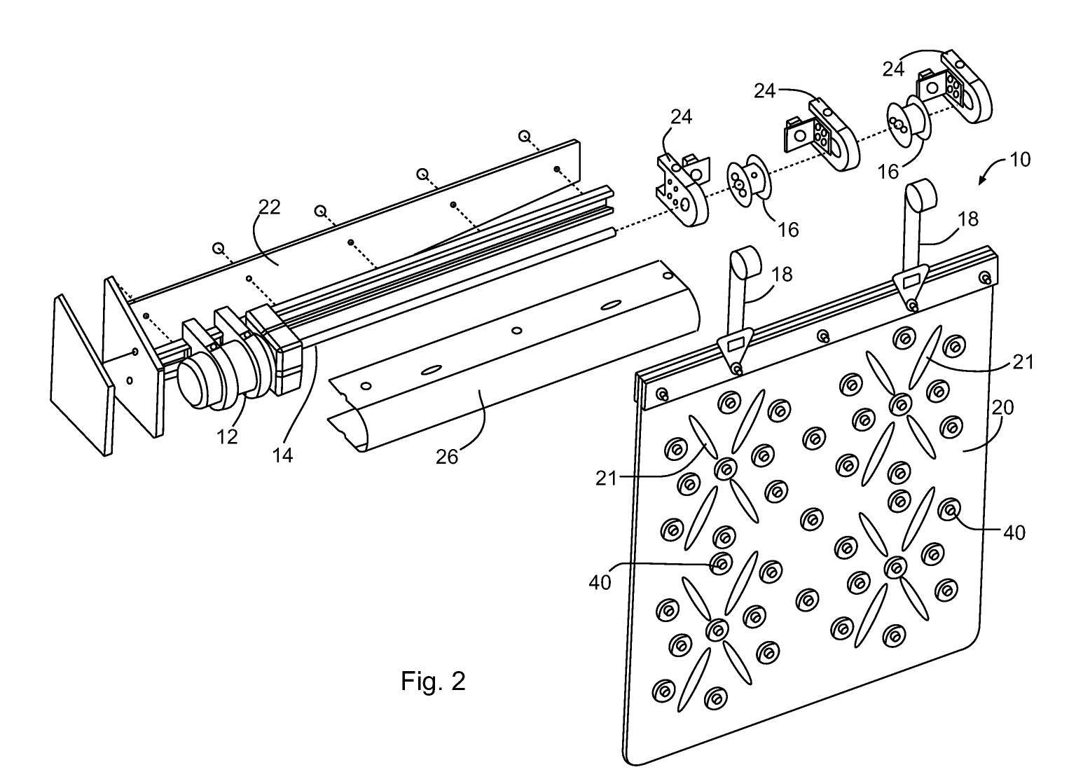

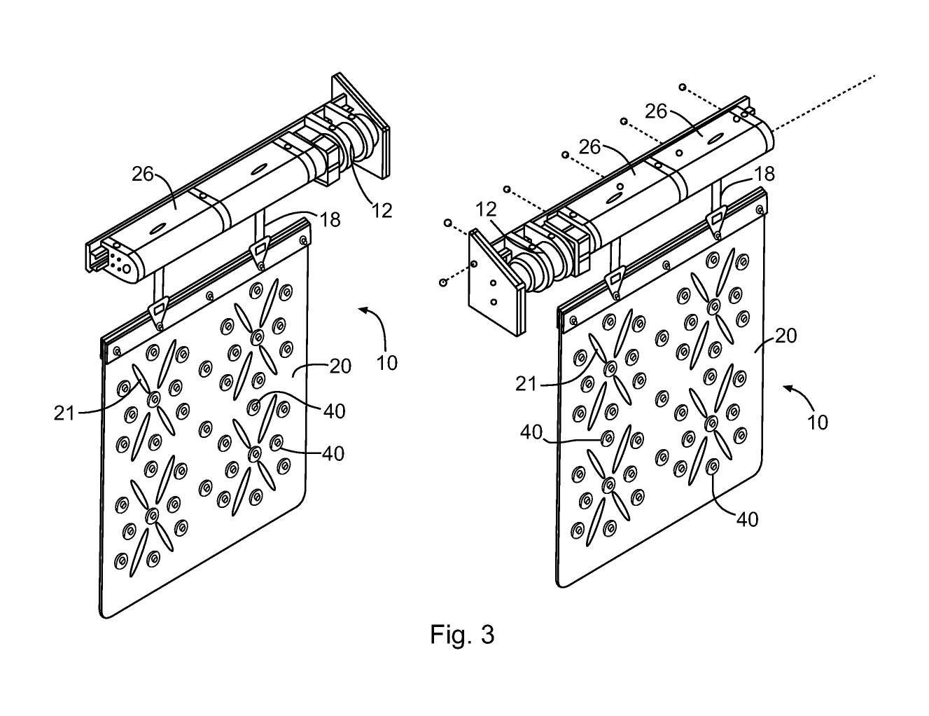

Referring to FIG. 1 a deployable traction assembly 10 comprises a motor 12 having a shaft 14, with two spools 16 mounted for rotation on the shaft 14. Two straps 18 each have a first end wound on a respective one of the spools 16 and a second end connected to a studded mud flap 20. Although two straps 18 are shown, in some embodiments there may be a single wide strap, which could form part of or be an extension of the studded mud flap 20, or there could be three or more straps 18 and spools 16. The motor 12 may be mounted on a backing plate 22 and the shaft 14 mounted on brackets 24 that allow rotation of the shafts 14 within the brackets 24 such as by a suitable bushing or bearing assembly. A cover 26 (FIGS. 2 and 3) may be provided for the motor 12, shaft 14 and spools 16. The straps 18 may pass through slots (not shown) in the cover 26.

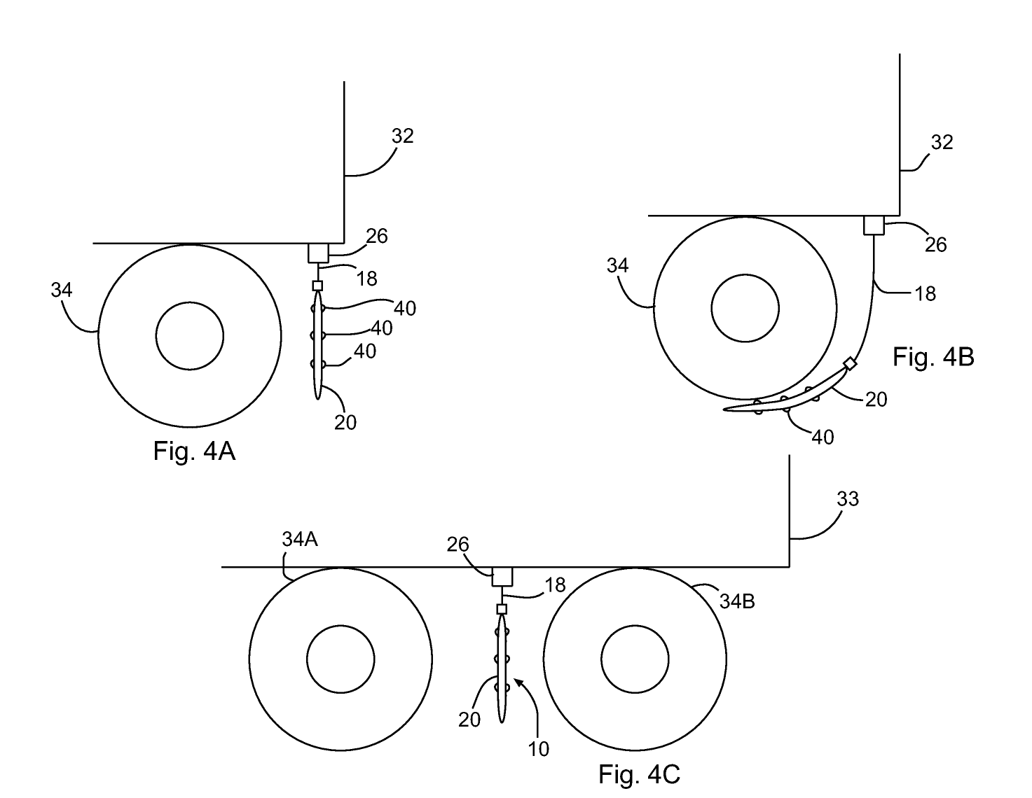

As shown in FIGS. 4A and 4B, in one embodiment, the deployable traction assembly 10 is mounted on a vehicle 32 behind a set of wheels 34 within a distance such that when the straps 18 are unwound from the spools 16 and the vehicle 32 moved backward, the studded mud flap 20 may extend under at least a wheel of the set of wheels 34. Preferably, the mud flap 10 extends under all wheels in a set of wheels. In FIG. 4C, a deployable mud flap 20 is mounted between two sets of wheels 34A, 34B on a vehicle 33 such as a tractor trailer, such that the mud flap traction device 10 may be deployed under the forward set of wheels 34A or the rearward set of wheels 34B depending on whether better traction would be achieved by moving forward or backward.

In one embodiment, the studded mud flap 20 has a first face 36 and a second face 38 (FIG. 4) and studs 40 protrude through the studded mud flap 20 and extend beyond each of the first face 36 and the second face 38.

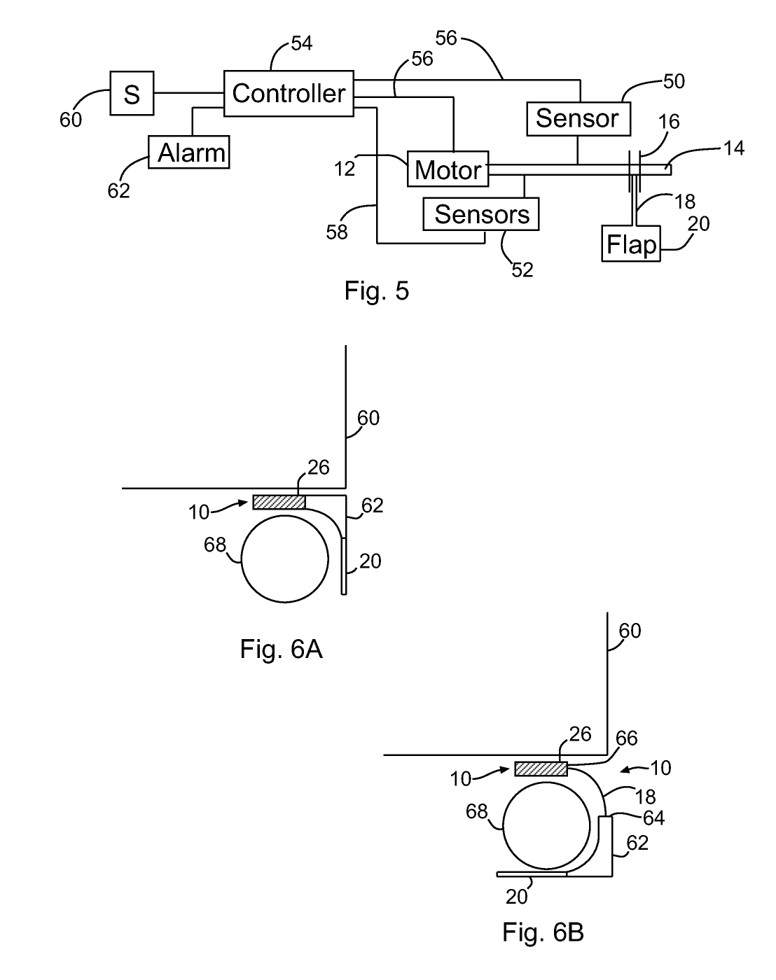

Referring to FIG. 5, the deployable traction assembly 10 may in some embodiments include one or both of a position sensor 50 and a load sensor 52 (and there could be more than one of each) to sense position of the studded mud flap 20 or load on the shaft 14, straps 18 or studded mud flap 20. The position sensor 50 may be supported on the plate 22 and detect for example movement of the shaft 14 or one or more of the spools 16. The load sensor 52 may be a conventional load sensor supported on the plate 22 and placed to detect load on the shaft 14 (effectively thus measuring load on the straps 18 and studded mud flap 20). A processor or controller 54 is connected via conventional communication channels 56 (could be wired or wireless) to receive signals from the sensors 50, 52 and provide output via conventional communication channel 58 for controlling the motor 12 based on the received signals. Programmable microprocessors are well known that are capable of being programmed (configured) for providing the control functions of controller 54. The motor 12 may be operated through controller 54, or directly if the controller 54 is omitted in some embodiments, by a switch 60 mounted in the cabin of the vehicle 32. An alarm 62, such as a visible or audible alarm, may be controlled by the controller 54 to warn of problems sensed by the sensors 50, 52.

In one embodiment, the processor 54 is configured on response to a start signal from switch 60 to run the motor 12 for a predetermined period of time. The processor 54 may be configured to respond to a load sensed by the sensor 52 beyond a predetermined threshold to send a rapid out-spool signal to the motor 12.

The electrical controls depicted for example in FIG. 5 may comprise a switch or set of switches 60 mounted on the dash in the cab to deploy or retract the flaps 20 in response to the driver's direct command. A more sophisticated version may include strain gauges (load sensors 52) and positional sensors 50 on the shaft 14 to sense forces being applied and keep track of the absolute position of the flaps 20. If the driver backs into a snow bank, for example, the strain gauges 52 would register an abnormal load and microprocessor 54 would immediately send a signal to the motors 12 to spool out the lines 18 on the mudflaps 20 to minimize strain so they are not ripped off. An indicator LED for each flap and audible alarms 62 in the cab may warn the driver of the situation. The positional sensor 50 may feedback on the position of the flaps 20 while this is occurring, keeping track of the distance the flaps 20 will need to be rewound to restore them to their rest positions as mud flaps 20. When the forces being applied to the flaps 20 decrease in response to the driver recognizing what has occurred, the microprocessor 54 may stop the outward spooling and attempt to retract the flaps 20 to their neutral positions, again looking for feedback from the strain gauges 52 to ensure that the flaps 20 are truly free to be retracted, and not just trapped on the other side of the wheels 34, for example.

Deployment for traction may rely on the same feedback mechanisms. A deployment switch 60 may send a signal to the motors 12 to spool out a predetermined distance so that the flaps 20 are properly situated under the wheels 34. The strain gauges 52 may provide feedback to notify the microprocessor 54 and the driver of an unexpected load, automatically adjusting the motors 12 to spool out additional line if necessary. There is a limit to the amount of line, of course, and if the straps 18 reach the end of this range, load-rated links (set for 300 pounds, say) at the juncture of the flaps and the straps would break free, dropping the flaps 20. This would trigger an alarm 62 in the cab to notify the driver of the loss.

In retract mode, the microprocessor 54 may send a signal to the motors 12 to rewind. Feedback from the strain gauges 52 may override this command as required to prevent the flaps 20 being detached (if the wheels are still on the flaps 20, for example). The advantage of this is that the driver could set the switch 60 to retract, and then slowly drive forward. As he does this, slack would be taken up by the motors 12, but only as fast as the wheels 34 are freeing the flaps 20. When the truck has moved off of the flaps 20 entirely, retraction would continue at full speed until the flaps 20 are returned to their neutral positions, at which point an LED and alarm 62 may inform the driver that all is well and he can drive on.

There are other advantages to a microprocessor-controlled version including the ability to set the neutral position anywhere to suit the tractor or trailer's physical dimensions and to compensate for different loads and driving conditions.

The straps 18 need not provide traction assist. The wheel to ground traction need only be mediated only by the studded mud flap 20. As mentioned elsewhere, the straps 18 may be attached to the mud flaps 20 through a load-limiting link, designed to break away at a predetermined load (for example about 1500 Newtons). The rated breaking point of the straps may for example be 2500 Newtons, but this could be increased if needed. Preferably, standard mounting for conventional mud flaps is used wherever possible for ease of installation, which consists of two ⅜″ bolts at one side of the assembly 10, and this (or more importantly, the shaft assembly) could be damaged by higher loads than 2500 Newtons.

A further failsafe that may be used in place of a microprocessor 54 is a solenoid used in concert with a clutch to release the shaft 14 and allow it to free-spin in the event the load on the mud flaps 20 exceeded a set limit (as when the driver is backing into a snow bank). In the processor embodiment, feedback from load cells 52 on each shaft 14 will be interpreted by the microprocessor 54, which will rapidly spool out the flaps 20 using the motors 12 to reduce the load, while simultaneously notifying the driver through a visual and audible alarm condition in the cab.

Various studs 40 may be used. Preferably, the mud flaps 20 should be reversible so that the assembly 10 could be mounted between two axles to go under either the front tires or the rear tires. This could be accomplished by installing standard studs from both sides, but avoiding a design that will damage the tires. It may also be desirable to comply with DOT standards for studded tires to avoid road damage although the risk of road damage is low considering that the traction pad 20 should remain stationary on the road surface. The flaps 20 therefore in one embodiment preferably have bi-directional studs in a matrix with inherent traction properties so that the flaps 20 can be deployed under wheels in front of the assembly 10 or behind the assembly 10. Many different materials may be used for the sheet portion of the mud flaps 20, for example fibre reinforced neoprene, preferably with inherent traction properties independent of the studs 40. In addition to the bi-directional studs, the matrix of the mud flap may have louvers 21 for directional airflow and to reduce air resistance (drag). The louvers 21 may be distributed across the mud flaps.

Referring to FIGS. 6A and 6B, a deployable traction assembly 10 mounted on vehicle 60 with straps 18 and mud flap 20 has a chock 62 secured at one side of the chock 62 to the end of the straps 18 furthest from the motor (not shown, but it is under the cover 26) and the mud flap 20 is attached to the other side of the chock 62. In the undeployed position shown in FIG. 6A, straps 18 are wound on the spools (not shown) and a square face 64 on the chock 62 abuts against a square face 66 on the cover 26 of the deployable traction assembly 10. Pressure of the two faces 64 and 66 against each other holds the chock 62 above the wheel 68. In the deployed position shown in FIG. 6B, the chock 62 rides down the wheel 68 until it contacts the ground where the wheels 68 of a reversing vehicle 60 can run up against the chock 62 and severely hinder or stop backward movement of the vehicle 60. The wheel chock 62 is preferably located at the top of the mud flap 20. Deployment of the chock 62 and flap 20 may be made independent from each other by providing separate straps for the chock 62 and mud flap 20. A trucker who needs to pull over because of fatigue and is on a long steady grade would deploy the chocks 62 in addition to his flaps 20 to further secure his vehicle. A domestic vehicle might deploy the chocks 62 when parking on a steeper grade where ice and snow is a problem such as a driveway after snowfall. A tow truck, bed truck, or sport utility vehicle for pulling or winching might require some of the same type of extra traction/security of the wheel chock in addition to the flap to lockdown its position when other methods might not be prudent or in addition to current methods.

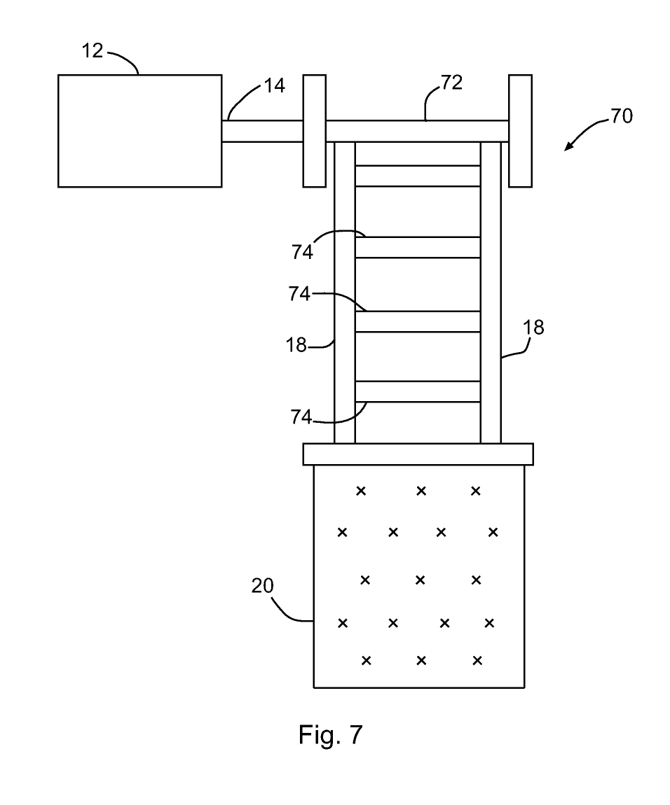

Referring to FIG. 7, a further embodiment of a deployable traction assembly 70 is shown in which straps 18 are wound on a single spool 72 on shaft 14 of motor 12. The straps 18 have traction elements 74 extending between the straps 18. The traction elements 74 may comprise cables or chains, and may be sufficiently stiff to hold the straps apart in operation. The straps 18 and traction elements 74 may also be replaced by a lengthened mud flap 20. The extra length of traction elements 74 may be used for example for rearward traction for the purpose of backing out of a stuck position as one might encounter in a ditch for example. Deployment of the flaps 20 may be continued to the maximum capacity while still providing traction to the tires even after they have driven off of the flap 20. This would be beneficial in the case where a vehicle is in a ditch or snowbank and may need a little extra to get out. The deployable mud flap assembly 10 may be used on roads that are made slippery by various conditions such as mud, snow and ice.

1. A deployable traction assembly, comprising:
a motor having a shaft;
one or more spools mounted for rotation on the shaft;
one or more straps, each strap having a first end wound on a respective one of the one or more spools and a second end; and
a studded mud flap connected to the second end of each of the one or more straps.

2. The deployable traction assembly of claim 1 mounted on a vehicle behind or in front of a set of wheels within a distance such that when the straps are unwound from the spools and the vehicle moved backward or forward respectively, the studded mud flap may extend under at least a wheel of the set of wheels.

3. The deployable traction assembly of claim 1 in which the studded mud flap has a first face and a second face and studs protrude through the studded mud flap and extend beyond each of the first face and the second face.

4. The deployable traction assembly of claim 1 further comprising:
one or more sensors connected to sense position of the studded mud flap or load on the one or more straps; and
a processor connected to receive signals from the one or more sensors and provide output for controlling the motor based on the received signals.

5. The deployable traction assembly of claim 4 in which the processor is configured on response to a start signal to run the motor for a predetermined period of time.

6. The deployable traction assembly of claim 4 in which the one or more sensors comprises a load sensor on the shaft of the motor and the processor is configured to respond to a load beyond a predetermined threshold to send a signal to the motor.

7. The deployable traction assembly of claim 1 in which the one or more spools comprise two spools and the one or more straps comprise two straps.

8. The deployable traction assembly of claim 2 in which the deployable traction assembly is mounted between first and second sets wheels on the vehicle.

9. The deployable traction assembly of claim 2 in which the deployable traction assembly is mounted rearward of all wheels on the vehicle.

10. The deployable traction assembly of claim 1 further comprising a chock that is deployable with or independently of the mud flap.

11. The deployable traction assembly of claim 1 in which traction elements are provided between the mud flap and the motor.

12. A vehicle having a deployable traction assembly, the deployable traction assembly comprising:
a studded mud flap mounted for retraction and extension on the vehicle by operation of a motor; and
the studded mud flap being mounted on the vehicle behind or in front of a set of wheels within a distance such that when the studded mud flap is extended and the vehicle moved backward, the studded mud flap may extend under at least a wheel of the set of wheels.

13. The vehicle of claim 12 in which the deployable traction assembly is mounted rearward of all wheels on the vehicle.

14. The vehicle of claim 12 in which the studded mud flap has a first face and a second face and studs protrude through the studded mud flap and extend beyond each of the first face and the second face.

15. The vehicle of claim 12 further comprising:
one or more sensors connected to sense position of the studded mud flap or load on the studded mud flap; and
a processor connected to receive signals from the one or more sensors and provide output for controlling the motor based on the received signals.

16. The vehicle of claim 15 in which the processor is configured on response to a start signal to run the motor for a predetermined period of time.

17. The vehicle of claim 15 in which the one or more sensors comprises a load sensor on a shaft of the motor and the processor is configured to respond to a load beyond a predetermined threshold to send a rapid spool-out signal to the motor.

18. The vehicle of claim 12 further comprising a chock deployable with or independently of the studded mud flap.

19. A deployable traction assembly, comprising:
a studded mud flap connected to a motor for retraction and extension when mounted on a vehicle;
one or more sensors connected to sense position of the studded mud flap or load on the studded mud flap; and
a processor connected to receive signals from the one or more sensors and provide output for controlling the motor based on the received signals.

20. The deployable traction assembly of claim 19 in which the studded mud flap has a first face and a second face and studs protrude through the studded mud flap and extend beyond each of the first face and the second face.

21. The deployable traction assembly of claim 19 in which the processor is configured on response to a start signal to run the motor for a predetermined period of time.

22. The deployable traction assembly of claim 19 in which the one or more sensors comprises a load sensor on a shaft of the motor and the processor is configured to respond to a load beyond a predetermined threshold to send a stop signal to the motor.
